(19) United States
(12) Patent Application Publication
(10) Pub. No.: US 2019/0207346 A1
(43) Pub. Date: Jul. 4, 2019

(54) ELECTRICAL CONNECTOR

(71) Applicant: LOTES CO., LTD, Keelung (TW)

(72) Inventors: Ted Ju, Keelung (TW); Chien Chih Ho, Keelung (TW)

(21) Appl. No.: 16/194,774

(22) Filed: Nov. 19, 2018

(30) Foreign Application Priority Data
Dec. 29, 2017 (CN) 201711467572.0
Nov. 9, 2018 (CN) 201811328710.1

(51) Int. Cl. H01R 13/6476; H01R 12/58

(52) U.S. Cl. CPC H01R 13/6476; H01R 12/58

(57) ABSTRACT

An electrical connector is used for electrically connecting an electrical component to a circuit board. The electrical connector includes: an insulating body; multiple terminals provided on the insulating body, each terminal having a contact portion for being in contact with the electrical component, a conducting portion for being conductively connected to the circuit board, and a connecting portion connecting the contact portion and the conducting portion; and an conductive member provided independently from the terminals and electrically connected to a corresponding one of the terminals, so as to reduce inductance of the corresponding one of the terminals.

### CROSS-REFERENCE TO RELATED PATENT APPLICATION

This non-provisional application claims priority to and the benefit of, pursuant to 35 U.S.C. § 119(a), patent application Serial No. CN201711467572.0 filed in China on Dec. 29, 2017, and patent application Serial No. CN201811328710.1 filed in China on Nov. 9, 2018. The disclosures of the above applications are incorporated herein in their entireties by reference.

Some references, which may include patents, patent applications and various publications, are cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference were individually incorporated by reference.

### FIELD

The present invention relates to an electrical connector, and more particularly to an electrical connector capable of improving the high-frequency performance.

### BACKGROUND

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

The Chinese patent No. CN201420377264.4 discloses an electrical connector, which includes an insulating body and multiple terminals provided on the insulating body. Each terminal has a contact arm. The contact arm has an assembly portion, an elastic portion bending and extending upward from the assembly portion and used for contacting a chip module, and a strip connecting portion assembled on the contact arm. The lower end of the strip connecting portion is connected to the assembly portion, and the upper end is used for connecting a strip. However, the upper end of the strip connecting portion is not in contact with the contact arm, thereby forming an “antenna.” When the terminal transmits current, an antenna effect may be generated, and the impedance of the terminal is increased. Thus, the transmission of a high-frequency signal is not facilitated.

Therefore, a heretofore unaddressed need to design a new electrical connection device exists in the art to address the aforementioned deficiencies and inadequacies.

### SUMMARY

In view of the deficiencies of the related art, the present invention is directed to a novel electrical connector so as to eliminate an antenna effect generated between two conductors which are detachably joined by pressure, thereby improving the signal transmission quality.

To achieve the foregoing objective, the present invention adopts the following technical solutions.

One aspect of the present invention provides an electrical connector, configured to electrically connect an electrical component to a circuit board, including: an insulating body; a plurality of terminals provided on the insulating body, each of the terminals having a contact portion configured to be in contact with the electrical component, a conducting portion configured to be conductively connected to the circuit board, and a connecting portion connecting the contact portion and the conducting portion; and a conductive member provided independently from the terminals and electrically connected to a corresponding one of the terminals, so as to reduce inductance of the corresponding one of the terminals.

In certain embodiments, an upper end and a lower end of the conductive member are electrically connected to the corresponding one of the terminals.

In certain embodiments, a gap is formed between a middle portion of the conductive member and the corresponding one of the terminals, and the middle portion is located between an upper end and a lower end of the conductive member.

In certain embodiments, the conductive member has a main body portion and an extending arm formed by extending from one end of the main body portion and abutting the contact portion of the corresponding one of the terminals.

In certain embodiments, the extending arm extends from an upper end of the main body portion and abuts a free end of the contact portion.

In certain embodiments, the conductive member has a surface completely adhered to the connecting portion of the corresponding one of the terminals.

In certain embodiments, the conductive member is soldered to the connecting portion of the corresponding one of the terminals.

In certain embodiments, a thickness of the connecting portion is smaller than a thickness of the conductive member.

In certain embodiments, the insulating body has a plurality of accommodating holes running through in a vertical direction, the terminals are correspondingly accommodated in the accommodating holes, the conductive member is provided between the connecting portion of the corresponding one of the terminals and a side wall of a corresponding one of the accommodating holes, and a gap is formed between the conductive member and the side wall of the corresponding one of the accommodating holes.

In certain embodiments, the conductive member is a solder soldered to the connecting portion of the corresponding one of the terminals.

In certain embodiments, the electrical component is installed to the electrical connector, allowing an electrical signal to be transmitted from the electrical component to the circuit board via the contact portion, the connecting portion, the conductive member and the conducting portion.

Another aspect of the present invention provides an electrical connector, configured to electrically connect an electrical component to a circuit board, including: an insulating body, provided with a plurality of accommodating holes; a plurality of terminals correspondingly accommodated in the accommodating holes, each of the terminals having a connecting portion accommodated in a corresponding one of the accommodating holes, a contact portion extending upward from the connecting portion and configured to be in contact with the electrical component, a conducting portion extending downward from the connecting portion and configured to be conductively connected to the circuit board, and a strip connecting portion extending from the connecting portion, wherein the terminals are connected to a strip by the strip connecting portions of the terminals, such that the terminals are installed in the accommodating holes by the strip; and a conductive member having two end portions respectively electrically connected to a corresponding one of the terminals, so as to reduce inductance of the corresponding one of the terminals.

In certain embodiments, a clamping mechanism is provided between the conductive member and the corresponding one of the terminals and is configured to fix the conductive member and the corresponding one of the terminals.

In certain embodiments, the clamping mechanism is provided between the conductive member and the connecting portion of the corresponding one of the terminals.

In certain embodiments, the connecting portion or the conductive member has a groove, and the conductive member or the connecting portion is clamped in the groove to form the clamping mechanism.

In certain embodiments, the groove is provided on the connecting portion, a size of the groove is greater than or equal to a size of the conductive member in a vertical direction, and the conductive member is clamped in the groove.

In certain embodiments, the groove is provided on the conductive member, and the connecting portion is clamped in the groove.

A further aspect of the present invention provides an electrical connector, configured to electrically connect an electrical component to a circuit board, including: a plurality of terminals, each of the terminals having a contact portion configured to be in contact with the electrical component, a conducting portion configured to be conductively connected to the circuit board, and a connecting portion connecting the contact portion and the conducting portion; and a conductive member provided on the connecting portion of a corresponding one of the terminals, wherein at least one clamping arm is electrically connected with the connecting portion of the corresponding one of the terminals and the conductive member, so as to reduce inductance of the corresponding one of the terminals.

In certain embodiments, the at least one clamping arm comprises at least one pair of clamping arms formed by extending from the connecting portion of the corresponding one of the terminals or the conductive member, so as to clamp the conductive member or the connecting portion of the corresponding one of the terminals.

In certain embodiments, the at least one clamping arm comprises two pairs of clamping arms respectively formed by extending from the connecting portion of the corresponding one of the terminals and opposite to each other in a vertical direction, so as to respectively clamp an upper end and a lower end of the conductive member.

In certain embodiments, the at least one clamping arm comprises two clamping arms respectively formed by extending from an upper end and a lower end of the conductive member to respectively clamp the connecting portion of the corresponding one of the terminals.

Compared with the related art, certain embodiments of the present invention has the following beneficial effects:

In the electrical connector of the present invention, the conductive member and the terminals are independently provided, and the conductive member are electrically connected to a corresponding one of the terminals, thereby preventing the conductive member from generating a severe antenna effect to affect the transmission of the high-frequency signal. Meanwhile, the conductive member essentially increases the volume of the terminals and increasing a path for transmitting the electrical signal, such that the impedance of the terminals is reduced, and the electrical connector can be well matched with the impedance of the electrical component and the circuit board, thereby improving the high-frequency transmission performance of the electrical connector.

These and other aspects of the present invention will become apparent from the following description of the preferred embodiment taken in conjunction with the following drawings, although variations and modifications therein may be effected without departing from the spirit and scope of the novel concepts of the disclosure.

### BRIEF DESCRIPTION OF THE DRAWINGS

The accompanying drawings illustrate one or more embodiments of the disclosure and together with the written description, serve to explain the principles of the disclosure. Wherever possible, the same reference numbers are used throughout the drawings to refer to the same or like elements of an embodiment, and wherein:

FIG. 1 is a perspective view of a terminal matching with a conductive member of an electrical connector according to a first embodiment of the present invention.

FIG. 2 is a perspective view of the electrical connector according to the first embodiment of the present invention.

FIG. 3 is a local section view of FIG. 2 along an A-A direction.

FIG. 4 is a schematic view of the electrical connector in FIG. 3 electrically connecting an electrical component and a circuit board.

FIG. 5 is a perspective view of a terminal matching with a conductive member of an electrical connector according to a second embodiment of the present invention.

FIG. 6 is a local side section view of a terminal installed on an insulating body in FIG. 5.

FIG. 7 is a schematic view of the electrical connector in FIG. 6 electrically connecting an electrical component and a circuit board.

FIG. 8 is a perspective view of a terminal matching with a conductive member of an electrical connector according to a third embodiment of the present invention.

FIG. 9 is a perspective view of a terminal matching with a conductive member of an electrical connector according to a fourth embodiment of the present invention.

FIG. 10 is a perspective view of a terminal matching with a conductive member of an electrical connector according to a fifth embodiment of the present invention.

FIG. 11 is a perspective view of a terminal matching with a conductive member of an electrical connector according to a sixth embodiment of the present invention.

FIG. 12 is an impedance curve diagram of the electrical connector according to the first embodiment of the present invention before the terminal is soldered to the conductive member and after the terminal is soldered to the conductive member.

### DETAILED DESCRIPTION

The present invention is more particularly described in the following examples that are intended as illustrative only since numerous modifications and variations therein will be apparent to those skilled in the art. Various embodiments of the invention are now described in detail. Referring to the drawings, like numbers indicate like components throughout the views. As used in the description herein and throughout the claims that follow, the meaning of “a”, “an”, and “the” includes plural reference unless the context clearly dictates otherwise. Also, as used in the description herein and throughout the claims that follow, the meaning of “in” includes “in” and “on” unless the context clearly dictates otherwise. Moreover, titles or subtitles may be used in the specification for the convenience of a reader, which shall have no influence on the scope of the present invention.

It will be understood that when an element is referred to as being “on” another element, it can be directly on the other element or intervening elements may be present therebetween. In contrast, when an element is referred to as being “directly on” another element, there are no intervening elements present. As used herein, the term “and/or” includes any and all combinations of one or more of the associated listed items.

Furthermore, relative terms, such as “lower” or “bottom” and “upper” or “top,” may be used herein to describe one element's relationship to another element as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The exemplary term “lower”, can therefore, encompasses both an orientation of “lower” and “upper,” depending of the particular orientation of the figure. Similarly, if the device in one of the figures is turned over, elements described as “below” or “beneath” other elements would then be oriented “above” the other elements. The exemplary terms “below” or “beneath” can, therefore, encompass both an orientation of above and below.

As used herein, “around”, “about” or “approximately” shall generally mean within 20 percent, preferably within 10 percent, and more preferably within 5 percent of a given value or range. Numerical quantities given herein are approximate, meaning that the term “around”, “about” or “approximately” can be inferred if not expressly stated.

As used herein, the terms “comprising”, “including”, “carrying”, “having”, “containing”, “involving”, and the like are to be understood to be open-ended, i.e., to mean including but not limited to.

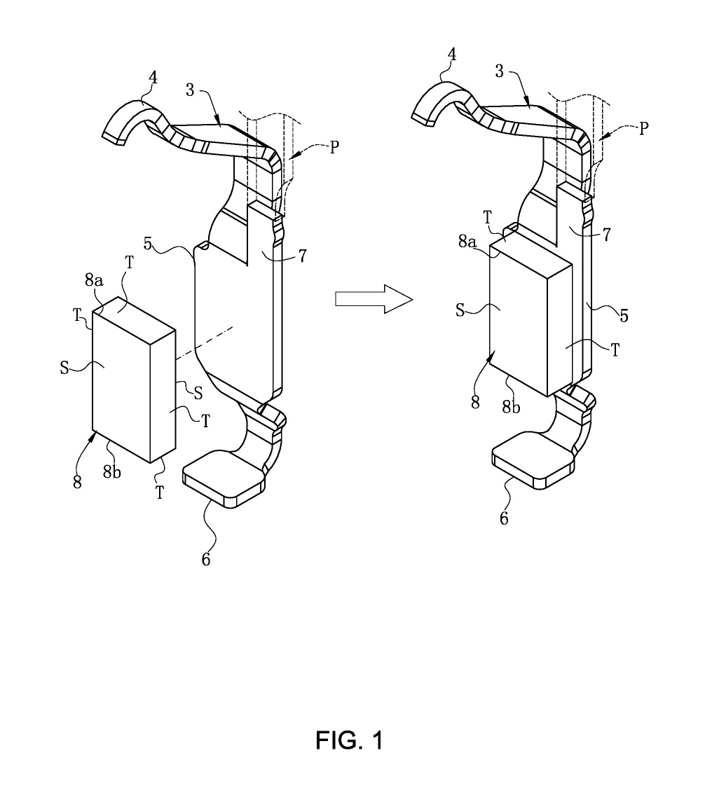

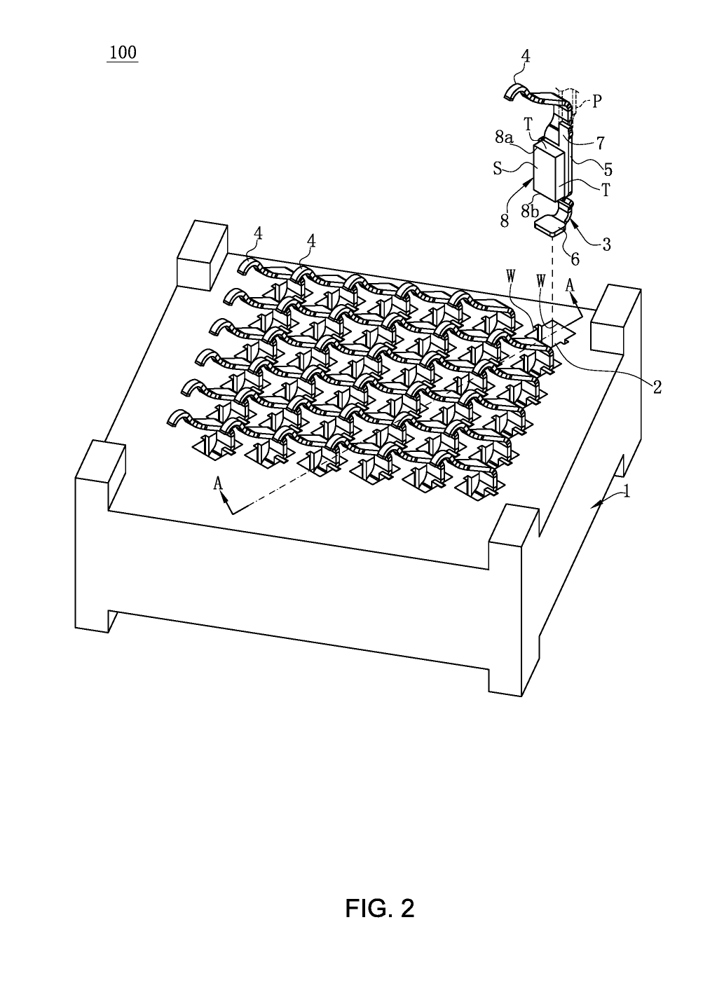

The description will be made as to the embodiments of the present invention in conjunction with the accompanying drawings in FIGS. 1-12. In accordance with the purposes of this invention, as embodied and broadly described herein, this invention, in one aspect, relates to an electrical connector.

As shown in FIG. 1 to FIG. 4, an electrical connector 100 according to a first embodiment of the present invention is provided. The electrical connector 100 is used for electrically connecting an electrical component 14 to a circuit board 16. The main components of the electrical connector 100 include: an insulating body 1, multiple terminals 3 provided on the insulating body 1, and multiple conductive members 8 correspondingly electrically connected on the terminals 3. In other embodiments, the electrical connector 100 can have only one conductive member 8, and the conductive member 8 is electrically connected to a corresponding one of the terminals 3, so as to reduce inductance of the corresponding one of the terminals 3. In this embodiment, the electrical component 20 is a chip module. In other embodiments, the electrical component 20 can be other electronic components.

The insulating body 1 is substantially in a cuboid shape. Multiple accommodating holes 2 are provided on the insulating body 1 running therethrough in a vertical direction to form an array, and each of the accommodating holes 2 has multiple side walls W.

The terminals 3 are correspondingly accommodated in the accommodating holes 2. Each terminal 3 has a connecting portion 5 accommodated in a corresponding one of the accommodating holes 2. Two different locations on the top end of the connecting portion 5 respectively extend upward to form a contact portion 4 and a strip connecting portion 7, and the lower end of the connecting portion 5 bends downward and extends to form a conducting portion 6. The contact portion 4 is formed by bending and extending. The strip connecting portion 7 is formed by extending vertically. The terminals 3 are respectively connected to a strip P by their corresponding strip connecting portions 7, such that the terminals 3 are installed in the accommodating holes 2 by the strip P, and then the strip P can be broken and removed.

Each of the conductive members 8 is provided independently from the terminals 3. The conductive members 8 are correspondingly accommodated in the accommodating holes 2 and correspondingly abut the terminals 3. Each conductive member 8 is in a cuboid shape, and has an upper end 8a and a lower end 8b opposite to each other in the vertical direction. The upper end 8a and the lower end 8b form the two end portions of each conductive member 8. In the present embodiment, the conductive member 8 is formed by punching a metal sheet, and has two opposite plate surfaces S and four cutting surfaces T connecting the two plate surfaces S.

As shown in FIG. 1, during assembling, firstly, one plate surface S of the conductive member 8 is completely adhered to the connecting portion 5 of the corresponding one of the terminals 3. By virtue of solder soldering or laser soldering, both the upper end 8a and the lower end 8b of the conductive member 8 are respectively in contact with the connecting portion 5 to form stable electrical connections. A thickness of the conductive member 8 is greater than a thickness of the connecting portion 5.

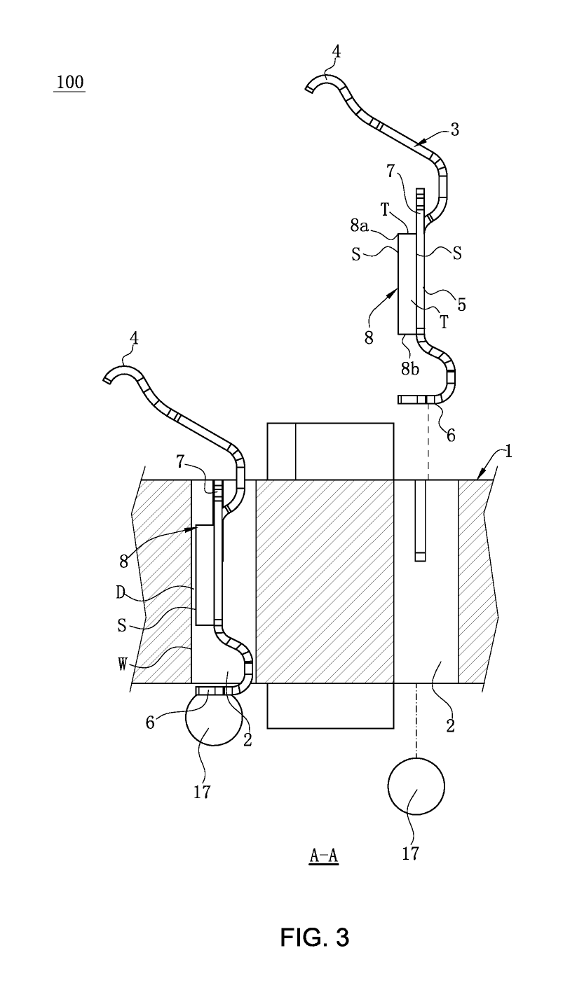

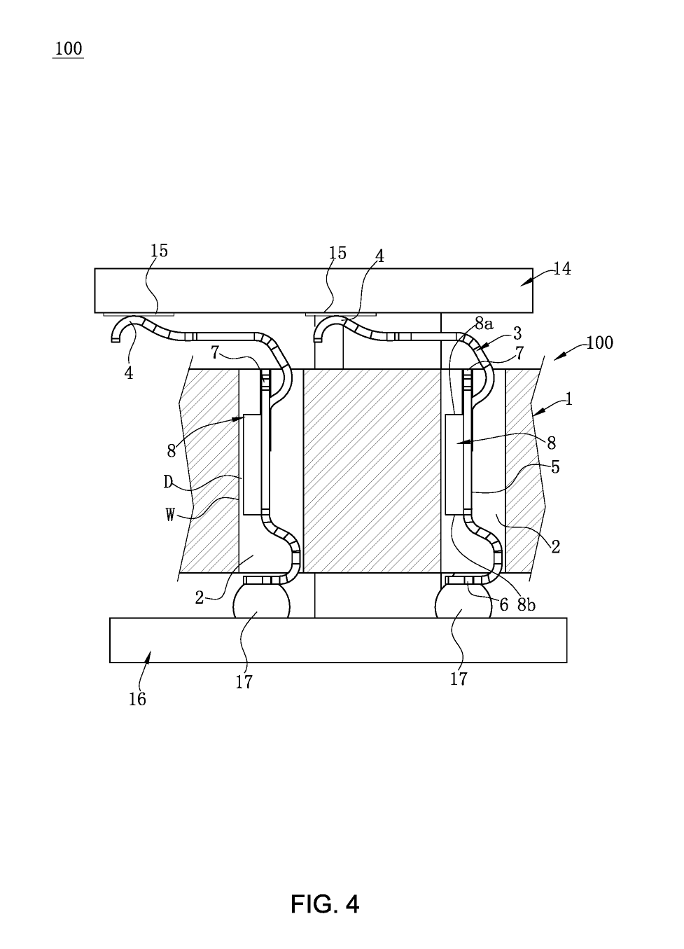

As shown in FIG. 3, the terminals 3 and the correspondingly fixedly soldered conductive member 8 are then jointly assembled into the corresponding accommodating holes 2, and the conductive member 8 is provided between the connecting portion 5 and one of the side walls W of a corresponding one of the accommodating holes 2, such that the other plate surface S of the conductive member 8 is right opposite to the one of the side walls W, and a gap D is formed between this plate surface S and the side wall W, thereby avoiding the interference between the conductive member 8 and the side wall W to result in the deviation of the terminal 3, and also preventing the conductive member 8 from scratching the side wall W. As shown in FIG. 4, the conducting portion 6 extends downward out of the accommodating hole 2 and is soldered to the circuit board 16 through a solder ball 17. The contact portion 4 extends upward out of the accommodating hole 2 from the connecting portion 5. The electrical component 14 is installed on the electrical connector 100, and multiple conductive sheets 15 of the electrical component 14 are respectively electrically conductive with the corresponding contact portions 4, such that an electrical signal outputted by the electrical component 14 can be transmitted to the circuit board 16 via the contact portion 4, the connecting portion 5, the conductive member 8 and the conducting portion 6. In this embodiment, the current flows through the upper end 8a and the lower end 8b of the conductive member 8, thereby preventing the conductive member from generating a severe antenna effect to affect the transmission of the high-frequency signal.

The conductive member 8 is connected into an electrical signal transmission path of the terminal 3, such that the thickness of the connecting portion 5 can be increased, the inductance of the terminal 3 is reduced, and a distance between two adjacent terminals 3 in a front-rear direction is also reduced, so as to increase the capacitance between the two adjacent terminals, and thereby reducing the impedance of the electrical connector 100.

The conductive member 8 can be made of a metal material such as a copper alloy, an aluminum alloy and the like, and even can be made of solder. For example, the conductive member 8 can be a solder block, a solder ball and the like, such that the conductive member 8 can be heated and fused to the connecting portion 5. In other embodiments, the conductive member 8 can also be made of other conductive materials such as graphite, conductive ceramics, conductive plastics and the like, such that the conductive member 8 can also be electrically connected to the terminal 3 in other manners. The conductive member 8 is not limited to the cuboid shape, and can also be provided in a prism shape, a cylindrical shape, an ellipsoid shape or other appropriate shapes.

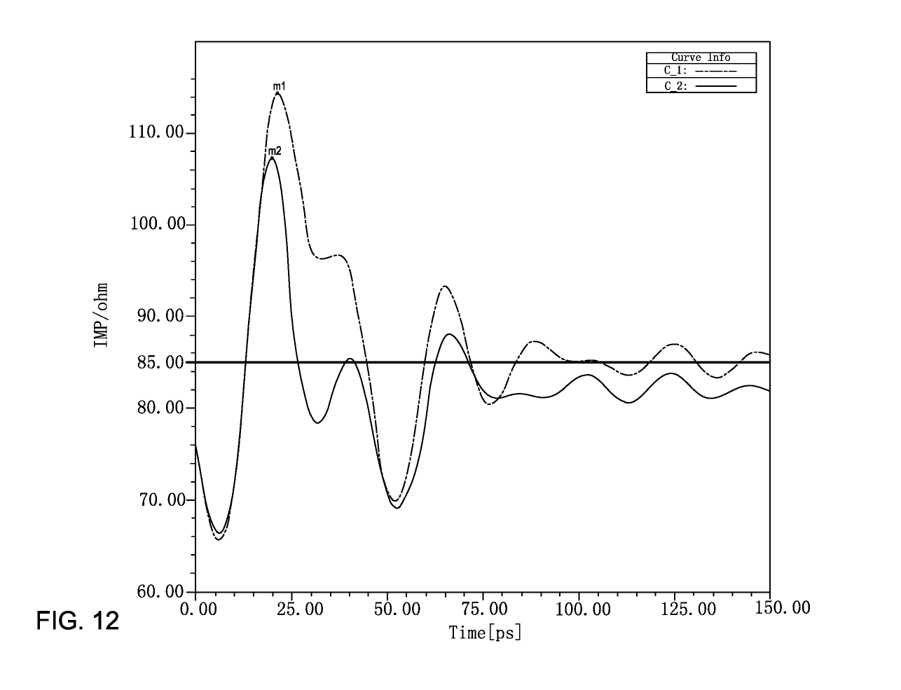

In view of the present embodiment, the respective characteristic impedances are respectively experimentally determined for the conductive terminals 3 not soldered with the conductive members 8 and the conductive terminals 3 soldered with the conductive members 8, as shown in FIG. 12.

As shown in FIG. 12, the curve C_1 is a characteristic impedance curve of the terminal 3 not soldered with the conductive member 8, and the curve C_2 is a characteristic impedance curve of the terminal 3 soldered with the conductive member 8. Taking an impedance value of 85Ω as a reference value, an impedance value of a highest point m1 of the curve C_1 is about 114.2Ω, which is over the reference value 85Ω by 34.4%, and an impedance value of a highest point m2 of the curve C_1 is about 107.3Ω, which is over the reference value 85Ω by 26.2%, and is decreased by 8.2% relative to m1. It can be seen that, after the conductive member 8 is soldered on the terminal 3, the impedance of the terminal 3 is significantly reduced so as to be closer to the reference value 85Ω, which is more favorable for the terminal 3 to meet the impedance matching requirement, thereby improving the high frequency transmission performance of the electrical connector 100.

Through further analysis, in general, the impedance Z0 of the terminal 3 is substantially equal to a square root of a ratio of inductance L to capacitance C. When a high-frequency signal is transmitted, the apparent skin effect of the high-frequency signal leads to the sensibility of the terminal 3, the impedance is relatively high, and the impedance matching requirement cannot be met. After the terminal 3 is soldered with the conductive member 8, the conductive member 8 increases a flow path of the electrical signal, such that the inductance L of the terminal 3 is reduced, the impedance of the terminal 3 is further reduced, and the terminal 3 can better meet the impedance matching requirement.

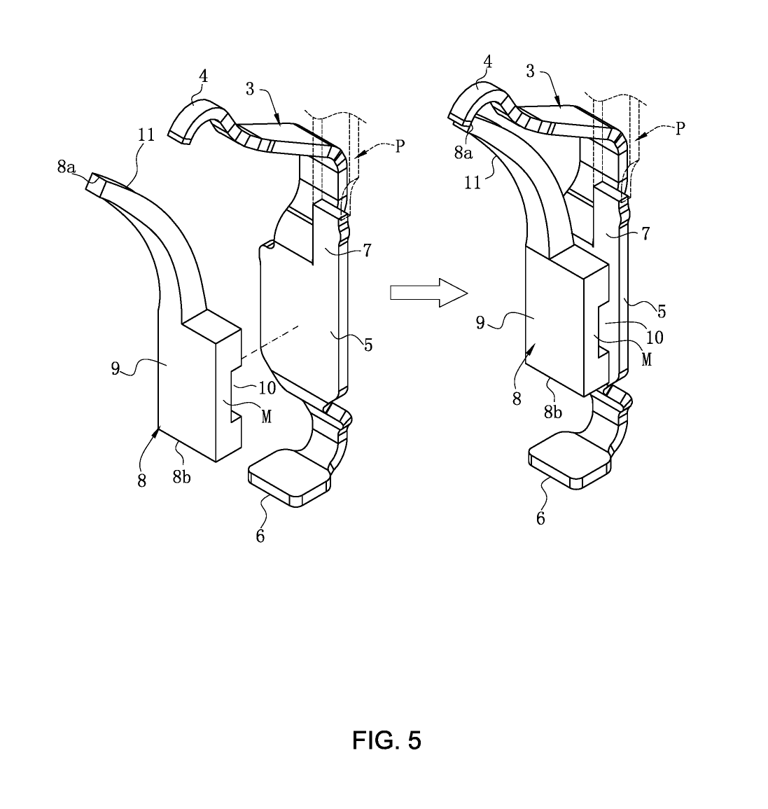

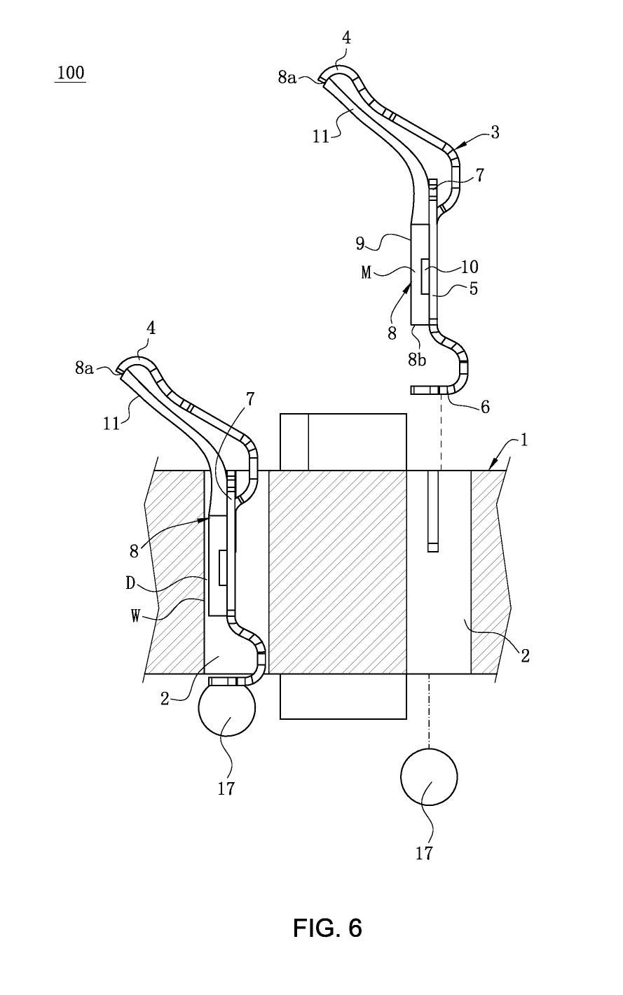

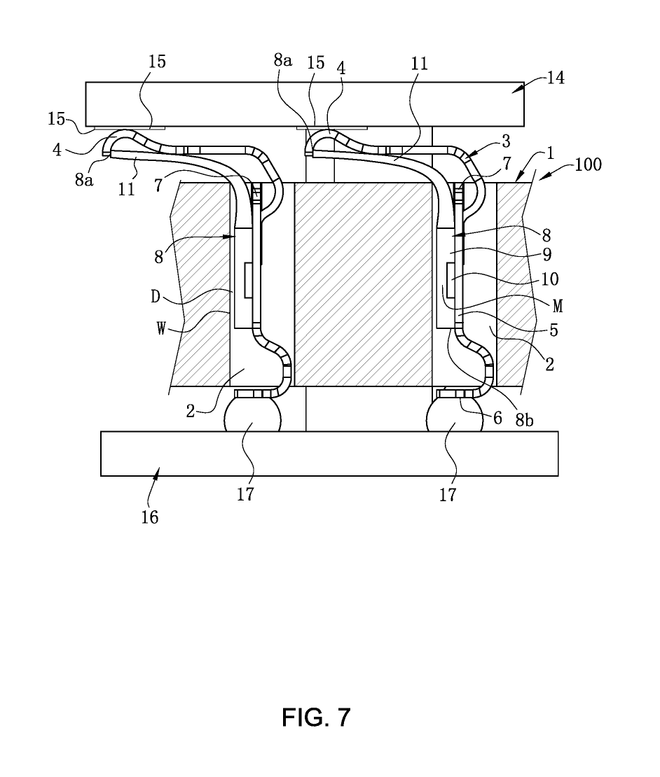

As shown in FIG. 5, FIG. 6 and FIG. 7, an electrical connector 100 according to a second embodiment of the present invention is provided. The embodiment is different from the first embodiment in that: the conductive member 8 has a main body portion 9 and an extending arm 11 extending upward from the top end of the main body portion 9 and abutting the tail end of the contact portion 4 of the corresponding one of the terminals 3, such that the originally suspended tail end of the contact portion 4 forms a current path through the extending arm 11 without generating the antenna effect to affect the transmission of the high-frequency signal. Meanwhile, both the top end and the bottom end of the main body portion 9 electrically contact the connecting portion 5 of the corresponding one of the terminals 3, and a gap 10 is provided between a middle portion M of the main body portion 9 and the corresponding connecting portion 5, such that the thickness of the main body portion 9 located at the gap 10 is smaller than the thickness of other portions of the main body portion 9, and the gap 10 can further adjust the impedance of the terminal 3 to be within an appropriate range.

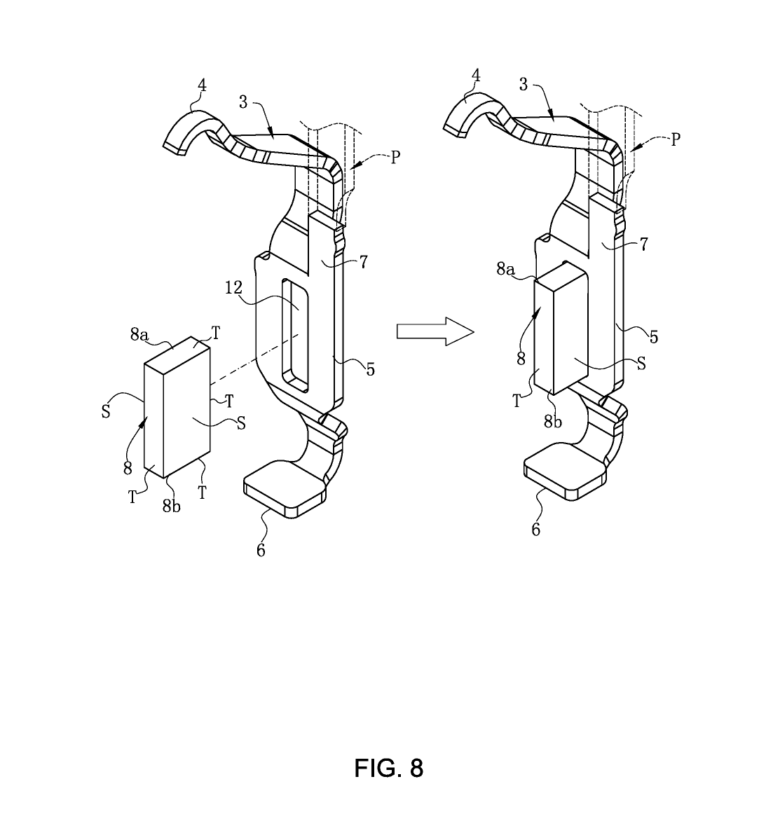

As shown in FIG. 8, an electrical connector 100 according to a third embodiment of the present invention is provided. The embodiment is different from the first embodiment in that: a clamping mechanism is provided between the conductive member 8 and the connecting portion 5 of the corresponding one of the terminals 3 so as to enable the two to be mutually retained. The connecting portion 5 has a lengthwise groove 12. A size of the groove 12 is equal to a size of the conductive member 8 in the vertical direction. A cutting surface T of the conductive member 8 is positioned to directly face the groove 12, and then the conductive member 8 is laterally clamped in the groove 12 to form the clamping mechanism. The upper end 8a and the lower end 8b of the conductive member 8 respectively electrically contact the upper side and the lower side of the groove 12, and two plate surfaces S of the conductive member 8 respectively electrically contact the left side and the right side of the groove 12. The conductive member 8 and the connecting portion 5 can be further fixed by soldering. In other embodiments, the size of the groove 12 can be greater than a size of the conductive member 8 in the vertical direction.

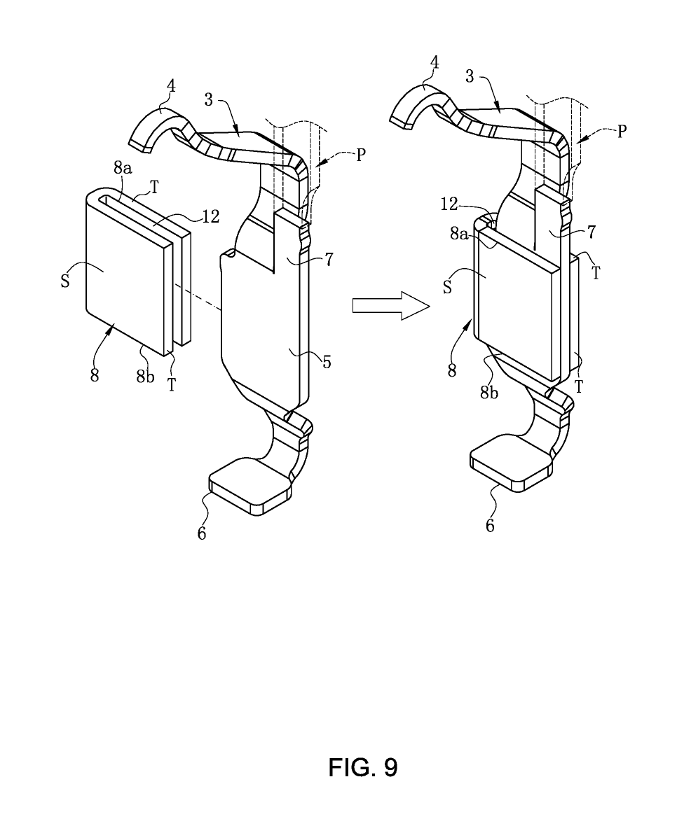

As shown in FIG. 9, an electrical connector 100 according to a fourth embodiment of the present invention is provided. The embodiment is different from the third embodiment in that: the groove 12 provided on the conductive member 8, and the groove 12 vertically runs through two cutting surfaces T of the conductive member 8. The groove 12 also penetrates through another cutting surface T of one side of the conductive member 8, such that the connecting portion 5 is clamped in the groove 12 along the cutting surface T of one side of the conductive member 8 to form the clamping mechanism.

The conductive member 8 having the same shape as that in the present embodiment may also be obtained by directly bending the flat conductive member 8 in the first embodiment, and then the conductive member 8 is bent to surroundingly form the groove 12.

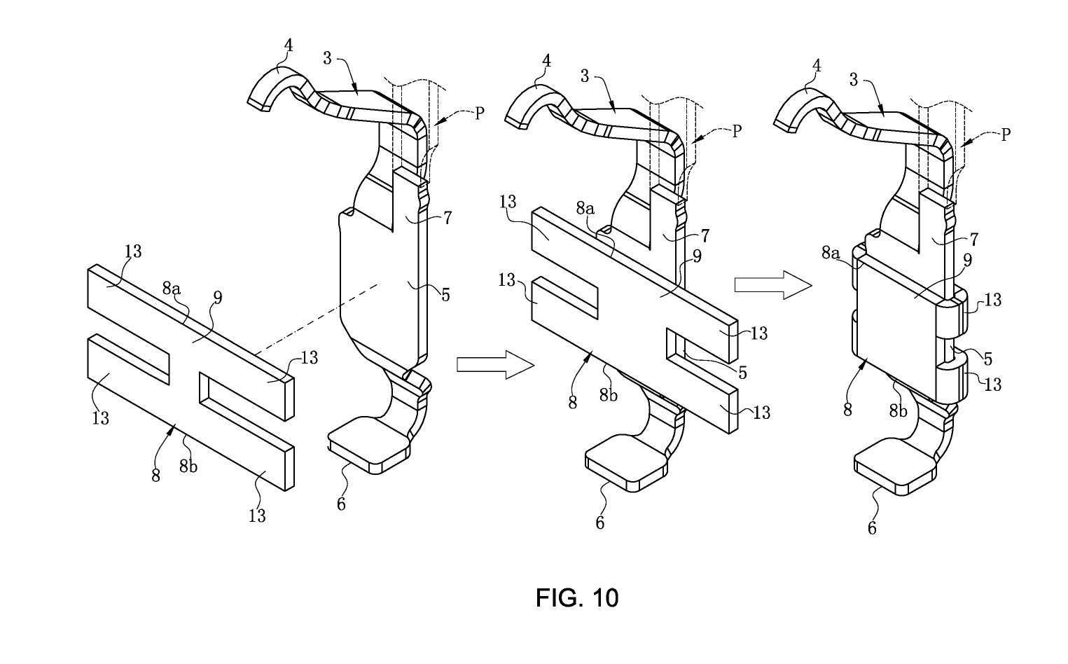

As shown in FIG. 10, an electrical connector 100 according to a fifth embodiment of the present invention is provided. The embodiment is different from the first embodiment in that: the conductive member 8 has a main body portion 9 and two pairs of clamping arms 13 respectively extending from the two sides of the upper end 8a and two sides of the lower end 8b of the main body portion 9, and the two pairs of clamping arms 13 collectively clamp the connecting portion 5 of the corresponding one of the terminals 3.

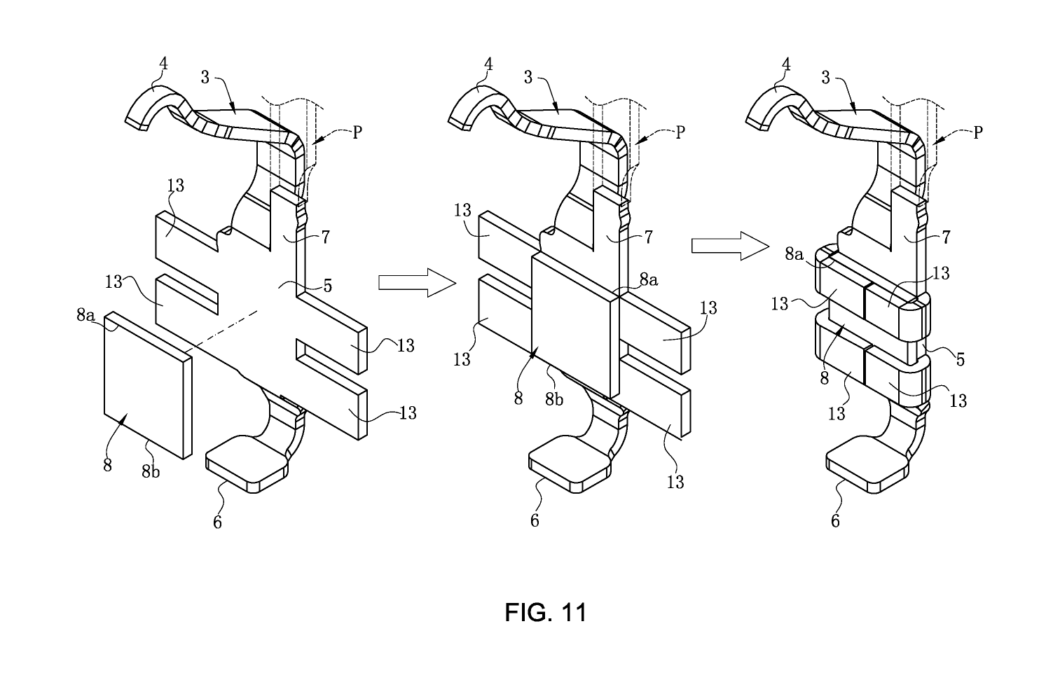

As shown in FIG. 11, an electrical connector 100 according to a sixth embodiment of the present invention is provided. The embodiment is different from the fifth embodiment 5 in that: two pairs of clamping arms 13 are provided on the connecting portion 5 and respectively clamp the upper end 8a and the lower end 8b of the conductive member 8.

In other embodiments, it is also desirable to provide only one clamping arm 13 or only one pair of the clamping arms 13, or two pairs of clamping arms 13 may be respectively provided on the terminal 3 and the conductive member 8.

To sum up, the electrical connector according to certain embodiments of the present invention has the following beneficial effects:

1. The conductive member 8 and the terminal 3 are independently provided, and the upper end 8a and the lower end 8b of the conductive member 8 are both electrically connected to the corresponding one of the terminals 3, thereby preventing the conductive member 8 from generating a severe antenna effect to affect the transmission of the high-frequency signal. Meanwhile, the conductive member 8 essentially increases the volume of the terminal 3 and increasing the path for transmitting the electrical signal, such that the impedance of the terminal 3 is reduced, and the electrical connector 100 can be well matched with the impedance of the electrical component 14 and the circuit board 16, thereby improving the high-frequency transmission performance of the electrical connector 100.

2. The conductive member 8 is electrically provided on the connecting portion 5 of the corresponding one of the terminals 3, and the conductive member 8 and the connecting portion 5 are clamped by at least one clamping arm 13, such that the stable electrical connection is formed by the conductive member 8 and the connecting portion 5, thereby effectively increasing the volume of the connecting portion 5, reducing the impedance of the terminal 3, and improving the high-frequency transmission performance of the electrical connector 100.

3. One end of the conductive member 8 forms an extending arm 11 abutting the tail end of the contact portion 4 of the corresponding one of the terminals 3, thereby preventing the tail end of the contact portion 4 from being suspended to generate the antenna effect and to influence the transmission quality of the high-frequency signal.

The foregoing description of the exemplary embodiments of the invention has been presented only for the purposes of illustration and description and is not intended to be exhaustive or to limit the invention to the precise forms disclosed. Many modifications and variations are possible in light of the above teaching.

The embodiments are chosen and described in order to explain the principles of the invention and their practical application so as to activate others skilled in the art to utilize the invention and various embodiments and with various modifications as are suited to the particular use contemplated. Alternative embodiments will become apparent to those skilled in the art to which the present invention pertains without departing from its spirit and scope. Accordingly, the scope of the present invention is defined by the appended claims rather than the foregoing description and the exemplary embodiments described therein.

What is claimed is:

1. An electrical connector, configured to electrically connect an electrical component to a circuit board, comprising:
an insulating body;
a plurality of terminals provided on the insulating body, each of the terminals having a contact portion configured to be in contact with the electrical component, a conducting portion configured to be conductively connected to the circuit board, and a connecting portion connecting the contact portion and the conducting portion; and
a conductive member provided independently from the terminals and electrically connected to a corresponding one of the terminals, so as to reduce inductance of the corresponding one of the terminals.

2. The electrical connector according to claim 1, wherein an upper end and a lower end of the conductive member are electrically connected to the corresponding one of the terminals.

3. The electrical connector according to claim 1, wherein a gap is formed between a middle portion of the conductive member and the corresponding one of the terminals, and the middle portion is located between an upper end and a lower end of the conductive member.

4. The electrical connector according to claim 1, wherein the conductive member has a main body portion and an extending arm formed by extending from one end of the main body portion and abutting the contact portion of the corresponding one of the terminals.

5. The electrical connector according to claim 4, wherein the extending arm extends from an upper end of the main body portion and abuts a free end of the contact portion.

6. The electrical connector according to claim 1, wherein the conductive member has a surface completely adhered to the connecting portion of the corresponding one of the terminals.

7. The electrical connector according to claim 1, wherein the conductive member is soldered to the connecting portion of the corresponding one of the terminals.

8. The electrical connector according to claim 1, wherein a thickness of the connecting portion is smaller than a thickness of the conductive member.

9. The electrical connector according to claim 1, wherein the insulating body has a plurality of accommodating holes running through in a vertical direction, the terminals are correspondingly accommodated in the accommodating holes, the conductive member is provided between the connecting portion of the corresponding one of the terminals and a side wall of a corresponding one of the accommodating holes, and a gap is formed between the conductive member and the side wall of the corresponding one of the accommodating holes.

10. The electrical connector according to claim 1, wherein the conductive member is a solder soldered to the connecting portion of the corresponding one of the terminals.

11. The electrical connector according to claim 1, wherein the electrical component is installed to the electrical connector, allowing an electrical signal to be transmitted from the electrical component to the circuit board via the contact portion, the connecting portion, the conductive member and the conducting portion.

12. An electrical connector, configured to electrically connect an electrical component to a circuit board, comprising:
an insulating body, provided with a plurality of accommodating holes;
a plurality of terminals correspondingly accommodated in the accommodating holes, each of the terminals having a connecting portion accommodated in a corresponding one of the accommodating holes, a contact portion extending upward from the connecting portion and configured to be in contact with the electrical component, a conducting portion extending downward from the connecting portion and configured to be conductively connected to the circuit board, and a strip connecting portion extending from the connecting portion, wherein the terminals are connected to a strip by the strip connecting portions of the terminals, such that the terminals are installed in the accommodating holes by the strip; and
a conductive member having two end portions respectively electrically connected to a corresponding one of the terminals, so as to reduce inductance of the corresponding one of the terminals.

13. The electrical connector according to claim 12, wherein a clamping mechanism is provided between the conductive member and the corresponding one of the terminals and is configured to fix the conductive member and the corresponding one of the terminals.

14. The electrical connector according to claim 13, wherein the clamping mechanism is provided between the conductive member and the connecting portion of the corresponding one of the terminals.

15. The electrical connector according to claim 14, wherein the connecting portion or the conductive member has a groove, and the conductive member or the connecting portion is clamped in the groove to form the clamping mechanism.

16. The electrical connector according to claim 15, wherein the groove is provided on the connecting portion, a size of the groove is greater than or equal to a size of the conductive member in a vertical direction, and the conductive member is clamped in the groove.

17. The electrical connector according to claim 15, wherein the groove is provided on the conductive member, and the connecting portion is clamped in the groove.

18. An electrical connector, configured to electrically connect an electrical component to a circuit board, comprising:
a plurality of terminals, each of the terminals having a contact portion configured to be in contact with the electrical component, a conducting portion configured to be conductively connected to the circuit board, and a connecting portion connecting the contact portion and the conducting portion; and
a conductive member provided on the connecting portion of a corresponding one of the terminals,
wherein at least one clamping arm is electrically connected with the connecting portion of the corresponding one of the terminals and the conductive member, so as to reduce inductance of the corresponding one of the terminals.

19. The electrical connector according to claim 18, wherein the at least one clamping arm comprises at least one pair of clamping arms formed by extending from the connecting portion of the corresponding one of the terminals or the conductive member, so as to clamp the conductive member or the connecting portion of the corresponding one of the terminals.

20. The electrical connector according to claim 18, wherein the at least one clamping arm comprises two pairs of clamping arms respectively formed by extending from the connecting portion of the corresponding one of the terminals and opposite to each other in a vertical direction, so as to respectively clamp an upper end and a lower end of the conductive member.

21. The electrical connector according to claim 18, wherein the at least one clamping arm comprises two clamping arms respectively formed by extending from an upper end and a lower end of the conductive member to respectively clamp the connecting portion of the corresponding one of the terminals.
